(19) United States
(12) Patent Application Publication
(10) Pub. No.: US 2002/0180215 A1
(43) Pub. Date: Dec. 5, 2002

(54) Method of producing electricity through injection of water into a well

(76) Inventor: Dell N. Mitchell, Declo, ID (US)

Correspondence Address: DYKAS, SHAVER & NIPPER, LLP, P O BOX 877, BOISE, ID, 83701-0877, US

(21) Appl. No.: 09/872,452

(22) Filed: Jun. 1, 2001

(51) Int. Cl. H02P 9/04; F03B 13/00

(52) U.S. Cl. 290/54

(57) ABSTRACT

A method of generating electricity utilizing the injection of water from a shallow well into a deeper well whereby the falling water is utilized to generate electricity.

### BACKGROUND OF THE INVENTION

The present invention generally relates to the generation of electricity, and more particularly relates to hydroelectric generation of electricity.

There is a great need for a clean and renewable method of generating electricity. Hydroelectric power is one method of generating such power. The source of the electricity is water, which through the use of gravity, powers turbines which can be used to generate electricity. Such type of electrical generation is commonly found along waterways throughout the world, including hydroelectric dams. Unlike the burning of fossil fuels, there are no pollutants which are released into the atmosphere through such type of electrical generation.

Known is the drilling of water wells of various depths in order to reach various aquifers or other underground structures. Typically, these wells range in depth from 20 feet to over 1,000 feet in depth. A primary aquifer may exist relatively shallow within an area, and likewise a secondary aquifer may be located at a much deeper depth. Various stratums may exist at various depths which would accept large amounts of water, for instance sand or gravel stratums. Wells can be drilled in various diameters, depending on the use: domestic home use usually utilizes a six-inch diameter well, and an irrigation well typically uses 36 inch (or larger) diameter wells. Wells can have static water levels, or may free-flow (artesian).

It is well known to inject water into the ground in order to assist in petroleum recovery. For instance, salt water can be pumped into an oil bed in order to cause oil in the bed to be more easily extracted therefrom. Known is also the use of deep injection holes where excess wastewater from flood-irrigated farms or winter runoff is allowed to drain. In U.S. Pat. No. 4,214,628 (Botts), noted is that “the gravity fall of water can be used to generate electricity for more efficient operation of the [Botts] system.”

What is needed is a method of producing power utilizing water pumped from a shallow well and injected a second well terminating in an aquifer or water receiving stratum. The present invention serves these needs.

### SUMMARY OF THE INVENTION

The present invention is a method of generating electricity through use of injecting water into a deep well. A source of water, whether it be a shallow well, a lake, a stream, the ocean, or other source, is transported to an injection well, where it is injected. Through this injection process, the water falls downwards through the assistance of gravity. At some point along its fall, the water drives an electrical generator turbine, thereby generating an electrical current. The water, after it exits the turbine, is ultimately reposited into either a permeable strata, such as sand or gravel, or into an aquifer.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a schematic view of one embodiment of the present invention.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

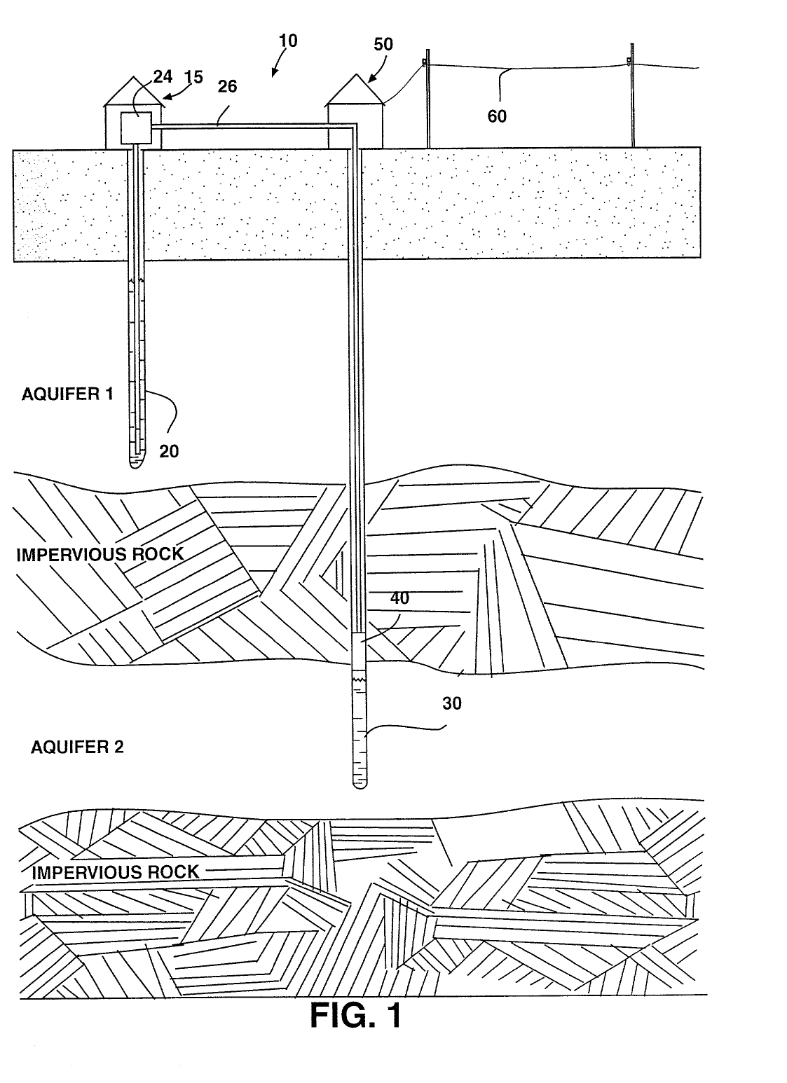

Referring to FIG. 1, the present invention 10 is a method of generating electricity. This method entails taking a source of water such as a shallow well, a river, a lake, a stream, a spring, a canal, a rain water run off, municipal or industrial discharge (treated wastewater, etc.), ocean water, etc., and injecting that source into a deeper well. The only requirement for such a source, aside from environmental regulations, is that the source be located above the discharge location discussed above.

Where the source of water 15 is a static first well 10 (“shallower” than the injection well), the water may need to be pumped from the well through use of a pump 24 or other means. Pumps may likewise be utilized with the other sources of water (lakes, discharge, ocean water, etc.). Electricity generated by the invented method may obviously be utilized to power such pumping equipment.

The source of water 15 must then be transported to an injection site 50. If the injection site 50 is near the source, such transportation may be minimal. A typical manner of transportation would be through pumping the water through a pipe(s) 26 from the source to the injection site. Other transportation methods, though less efficient, are also envisioned. For instance, including, but not limited to, hauling the water through canals, ditches, etc.

At the injection site, this source of water is injected into a deep well 30. Such a “deep well” being located deeper than the source of the water so that gravity can be utilized to accelerate the fall of the water. This deep well can include wells which were drilled but were dry, and wells having very deep static water tables.

Due to the vertical drop (depending upon depth), a high amount of pressure would be produced that can be utilized to drive a hydroelectric turbine or generator 40 for the purpose of generating electricity. This generated electricity is transmitted back out of the well and utilized in the standard manner, such as distribution into standard electrical lines 60 for sale or use by the producer. The injected water, after it has been used to drive the generator, is injected into an aquifer, gravel bed strata, or sand bed strata.

In one embodiment of the present invention (as reflected in FIG. 1), the source of water is a shallower well 20 located in a first aquifer. In such an embodiment, the water from the shallower well would be pumped from the shallower well into the deeper (injection) well 30 having a bottom in a second aquifer. In such a manner, this embodiment of the invented method merely utilizes being moved from one aquifer to a second aquifer for the generation of electricity. While FIG. 1 shows aquifers bounded by impervious rock, the present invention is appropriate for use with any suitable geological formation.

The hydroelectric generator 40 utilized with the present invention can be of any typical means, including but not limited to reverse turbines, submersible generators and/or submersible turbines.

The invented method will work best with artesian wells with high pressure and large volumes of water located close to the drilled injection well because an operator could easily divert water down the injection well with a minimum (or no) pumping required. By reducing or eliminating pumping, the costs associated with pumping (electricity, hardware, etc.) is eliminated.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

I claim:

1. A method of generating electricity, said method comprising the steps of:
providing a shallow well and a deep well, wherein said deep well is deeper than said shallow well;
placing a hydroelectric generator in said deep well;
providing a pump fluidly connected to said shallow well;
pumping a quantity of water from said shallow well;
transporting said quantity of water to said deep well;
injecting said quantity of water into said deep well; and
utilizing said injected water to create electricity through use of said generator.

2. The method of claim 1, wherein, said created electricity is utilized to power said pump.

3. The method of claim 1 wherein said deep well has a static level of water.

4. The method of claim 1 wherein said deep well has a gravel stratum able to accept large amounts of water.

5. The method of claim 1 wherein said deep well has a sand stratum able to accept large amounts of water.

6. The method of claim 1 wherein said hydroelectric generator is a reverse turbine.

7. The method of claim 1 wherein said hydroelectric generator is a submersible generator.

8. A method of generating electricity, said method comprising the steps of:
providing a shallow well of water and a deep well having a static level, wherein said deep well is deeper than said shallow well;
placing a hydroelectric generator in said deep well;
providing a pump fluidly connected to said shallow well;
pumping a quantity of water from said shallow well;
transporting said quantity of water to said deep well;
injecting said quantity of water into said deep well; and
utilizing said injected water to create electricity through use of said generator.

9. The method of claim 8, wherein, said created electricity is utilized to power said pump.

10. The method of claim 8 wherein said hydroelectric generator is a reverse turbine.

11. The method of claim 8 wherein said hydroelectric generator is a submersible generator.

12. A method of generating electricity, said method comprising the steps of:
providing a shallow well and a deep well, wherein said deep well is deeper than said shallow well;
placing a hydroelectric generator in said deep well;
providing a pump fluidly connected to said shallow well;
pumping a quantity of water from said shallow well;
transporting said quantity of water to said deep well;
injecting said quantity of water into said deep well; and
utilizing said injected water to create electricity through use of said generator, wherein, said created electricity is utilized to power said pump.

13. The method of claim 12 wherein said hydroelectric generator is a reverse turbine.

14. The method of claim 12 wherein said hydroelectric generator is a submersible generator.

15. The method of claim 12 wherein said deep well has a static level of water.

16. The method of claim 12 wherein said deep well has a gravel stratum able to accept large amounts of water.

17. The method of claim 12 wherein said deep well has a sand stratum able to accept large amounts of water.
